(19) United States
(12) Patent Application Publication
(10) Pub. No.: US 2026/0337743 A1
(43) Pub. Date: Oct. 29, 2026

(54) HIGH STIFFNESS METAL FOR SEMICONDUCTOR PROCESS TOOLS

(71) Applicant: Applied Materials, Inc., Santa Clara, CA (US)

(72) Inventors: Dorothea Buechel-Rimmel, Santa Clara, CA (US); Joseph Behnke, San Jose, CA (US); Marc Shull, Los Gatos, CA (US); Matvey Farber, Redwood City, CA (US); Paul Wirth, Kalispell, MT (US)

(21) Appl. No.: 19/654,961

(22) Filed: Apr. 22, 2026

Related U.S. Application Data
(60) Provisional application No. 63/792,986, filed on Apr. 23, 2025.

(51) Int. Cl. C22C 49/06; B25J 11/00; B25J 15/00

(52) U.S. Cl. CPC C22C 49/06; B25J 11/0095; B25J 15/0014

(57) ABSTRACT

Disclosed in some embodiments is an end effector for a robot arm. The end effector includes a metal end effector body and a reinforcement feature attached to the metal end effector body. The reinforcement feature includes a metal matrix composite comprising a metal matrix and a plurality of fibers in the metal matrix. The metal end effector body has a stiffness similar to stainless steel as a result of the reinforcement feature.

### CROSS REFERENCE TO RELATED APPLICATION(S)

The present application claims priority to U.S. Provisional Patent Application No. 63/792,986 filed on Apr. 23, 2025, the entire contents of which are incorporated in its entirety.

### TECHNICAL FIELD

Embodiments of the present disclosure relate generally to semiconductor process tools (such as an apparatus for transferring objects in a processing system), and methods for preparing the semiconductor process tools. In certain embodiments, the present disclosure relates to an end effector of a robot arm including a reinforcement feature.

### BACKGROUND

In electronic device manufacturing, substrates (e.g., silicon-containing wafers, silicon-containing plates) may be moved about manufacturing facilities and within manufacturing equipment tools by robots. The robots can include robot arms having one or more end effectors coupled thereto that may contact and support the substrates during such transportation. End effectors include contact pads thereon that provide elevated contact surfaces upon which the substrates are supported.

The manufacturing equipment tools are often made from metal alloy, such as an aluminum alloy commonly Al6061. As the tools move the substrate, it has been found that the tools vibrate, causing the substrate to move on the end effectors or fall out of the tool. This can cause a variety of problems, such as generating particles on the substrate, which can cause processing problems, or vibration because of low material stiffness may limit move speed and throughput.

### SUMMARY OF THE DISCLOSURE

In certain embodiments, the present disclosure may be directed to an end effector for a robot arm. The end effector may include a metal end effector body and a reinforcement feature attached to the body. In some embodiments, the reinforcement feature may include a metal matrix composite. The metal matrix composition may include a metal matrix and a plurality of fibers in the metal matrix.

In certain embodiments, the present disclosure may be directed to a robot. The robot may include a robot arm. In some embodiments, the robot arm may include an end effector. The end effector may include a metal end effector body and a reinforcement feature attached to the body. In some embodiments, the reinforcement feature may include a metal matrix composite. The metal matrix composition may include a metal matrix and a plurality of fibers in the metal matrix.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates a perspective view of an example of a metal end effector including one or more contact pads provided in accordance with an embodiment of the present disclosure.

FIG. 2 depicts a perspective side/top view of a metal end effector body including a reinforcement feature in accordance with an embodiment of the present disclosure.

FIG. 3 depicts a bottom view of a metal end effector body including a reinforcement feature in accordance with an embodiment of the present disclosure.

FIG. 4 illustrates a top schematic view of an electronic device manufacturing apparatus including a transfer robot having an end effector including replaceable contact pads that may be together coated in accordance with one or more embodiments of the present disclosure.

### DETAILED DESCRIPTION

In electronic device manufacturing processes, substrates (e.g., silicon wafers, silicon-containing plates, etc.) configured to produce electronic components (e.g., electronic chips or electronic subcomponents thereof) are moved, often via use of one or more robots, through a number of manufacturing steps. The robots include end effectors that support the substrates during such movements. Moving substrates very quickly can increase throughput and reduce manufacturing costs of the produced electronic components.

The rapid movement of robots when transporting substrates may generate charged particles that can gather on surfaces and in turn contribute to substrate defects. The rapid movements may also cause the end effectors and/or substrates on the end effectors to vibrate, or may further cause the substrate to shift position on the end effector and/or fall off the end effector, potentially causing production slow downs, causing production inaccuracies (e.g., misalignment of features), and/or damaging the substrates. Past attempts to prevent the shifting of substrates on end effectors included coating surfaces of the end effectors (e.g., with high roughness coating). However, such coatings may be minimally effective, and may introduce further complications, such as scratches to the backside of substrates.

Accordingly, there is generally a throughput limitation currently experienced by transfer chamber robots and/or factory interface robots with respect to the transfer of substrates (e.g., between chambers). For example, robots may be paused briefly after a movement to provide a mechanical subsystem settling time. During the mechanical subsystem settling time, vibrations of the end effector caused by the movement may dissipate. After the vibrations have dissipated, then movement of the robot may continue. Additionally, movement speeds of the robot arms may be reduced in systems to avoid substrate sliding, substrate (backside) damage, substrate (backside) contamination, substrate handling tool damage (e.g., such as contamination issues), and so on.

Throughput can also be improved by thinning of the end effector which permits to reduce volume of slit valves (reduce volume of vacuum system, reduce pump down time).

In embodiments, end effectors are entirely or partially formed from a high stiffness modified metal that includes a metal matrix composite comprising a metal matrix and a plurality of fibers in the metal matrix. For example, an end effector of a robot may be formed of a metal end effector body and a reinforcement feature attached to the metal end effector body, the reinforcement feature comprising the metal matrix composite comprising the metal matrix and the plurality of fibers in the metal matrix. Use of the high stiffness modified metal improves the material properties of the end effector, such as stiffness. This material can be used to form all or part of the end effector and/or of other components of the robot. For example, this material may be used as a reinforcement feature in an end effector and/or other robot part (e.g., a link of a robot arm), and will be described in further detail below. The material described herein includes a metal matrix composite including a metal matrix and a plurality of fibers in the metal matrix.

It has been found that the metal matrix composite of the present disclosure has similar stiffness to stainless steel, while maintaining the weight of aluminum and/or an aluminum alloy. The metal matrix composite also minimizes vibration of robot arm movement (e.g., vibration of an end effector caused by robot arm movement). Additionally, when components (e.g., an end effector) of a robot are reinforced with or formed by the metal matrix composite, such components have been shown to cause minimal or no substrate movement during transfer and/or reduced or prevented particle generation, while also enabling substrates to be moved at an increased target speed.

The instant disclosure encompasses various embodiments relating to a metal matrix composite and a reinforcement feature include the same. The metal matrix composite described herein may be advantageous and cost effective for use in manufacturing of robot arms (e.g., end effectors, links, etc. of robot arms). In embodiments, bare chamber components (such as end effector bodies) that are manufactured from conventional materials (e.g., aluminum or an aluminum alloy) are provided, which face minimal manufacturing and yield issues, have short lead times, and so on. The metal matrix composite (e.g., a layer, feature, portion, or block made of the metal matrix composite) may be added to components of the robot as a reinforcement feature. In some embodiments, the component (e.g., end effector) may be manufactured mostly (e.g., more than 50%) or entirely from the metal matrix composite. In some embodiments, the metal matrix composite may include fibers in an amount of less than about 50%. For example, the metal matrix composite may include fibers in an amount of about 25%, which was found to be easier to machine.

In an embodiment, the present disclosure may be directed to a component for transporting substrates that includes a reinforcement feature having certain properties. In one embodiment, the component for transporting substrates may be an end effector for a robot arm. The end effector may have properties similar to stainless steel in embodiments, but may be formed from an aluminum or aluminum alloy with one or more reinforcement features formed thereon or therein. For example, the end effector may have a stiffness of at least about 70 GPa, at least about 90 GPa, at least about 100 GPa, at least about 120 GPa, at least about 150 GPa, or at least about 200 GPa. In some embodiments, the end effector may have a stiffness of about 200 GPa to about 250 GPa. The reinforcement feature may extend along a longitudinal axis of the body of the end effector. In some embodiments, the reinforcement feature may be disposed in at least one of a first cavity on a top surface of the body of the end effector or a second cavity on a bottom surface of the body of the end effector. In some embodiments, the reinforcement feature may by a layer (e.g., a thin layer) of a metal matrix composite disposed on a top and/or bottom of the end effector. A body of the component for transporting substrates (e.g., end effector) may include a metal. The metal may include aluminum, an aluminum alloy, or a metal matrix composite as described herein. In an embodiment of the present disclosure, the metal matrix composite may include a metal matrix and a plurality of fibers in the metal matrix. In some embodiments, the plurality of fibers may include continuous fibers, discontinuous fibers, and/or particulates. In an embodiment, the plurality of fibers may include continuous fibers. When the plurality of fibers are continuous fibers, it has been found that the material properties of the metal may be improved and/or enhanced. For example, a metal matrix filled with continuous fibers may exhibit stiffness, tensile strengths, compressive strengths, and/or moduli of elasticity typically greater than conventional materials of similar size or weight. Thus, this provides for components in the robot having superior mechanical properties than those formed of traditional materials.

In some embodiments, the metal matrix composite may be a continuous fiber reinforced metal matrix composite. Continuous fiber reinforced metal matrix composites may have continuous fibers embedded in a metal matrix. In some embodiments, the metal matrix of the metal matrix composite may include a light weight metal, such as aluminum, an aluminum alloy, magnesium, a magnesium alloy, or similar. In some embodiments, the metal matrix of the metal matrix composite may include aluminum or an aluminum alloy, which may correspond to an aluminum or aluminum alloy used to form a body that a reinforcement feature formed from the metal matrix composite is bonded (e.g., welded) to.

In some embodiments, the continuous fibers of the metal matrix composite may include, but are not limited to, aluminum oxide (alumina) fibers, basalt fibers, glass fibers, silicon oxide, quartz fibers, boron fibers, silicon carbon fibers, carbon fibers, or a combination thereof. In some embodiments, the fibers may be crystalline or amorphous. In some embodiments, the continuous fibers may be oriented parallel to the length (e.g., longitudinal axis) of a body of the metal matrix composite. In some embodiments, the continuous fibers may be oriented to be transverse to the longitudinal axis of the body of the metal matrix composite, or any orientation between parallel and transverse to the length of the metal matrix composite.

In some embodiments, the component for transporting substrates that includes a reinforcement feature including the metal matrix composite may be an end effector. The end effector may be a metal end effector. The end effector may include an end effector body. The end effector body may optionally include replaceable contact pads thereon for reducing and/or eliminating slipping of a substrate from the surface of the end effector during transport.

As used herein, the singular forms “a,” “an,” and “the” include plural references unless the context clearly indicates otherwise. Thus, for example, reference to “a wafer” includes a single wafer as well as a mixture of two or more wafers; and reference to a “metal” includes a single metal as well as a mixture of two or more metals, and the like.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. In certain embodiments, the term “about” includes the recited number ±10%, such that “about 10” would include from 9 to 11.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

Certain embodiments are discussed herein with reference to an end effector including a metal matrix composite as described herein. However, it should be understood that the metal matrix composite described in embodiments herein may also be used in connection with other components of processing chambers, transfer chambers, factory interface chambers, load locks, load ports, slit valves, and so on. Accordingly, the metal matrix composite and/or reinforcement feature described herein may be attached to, or used to manufacture, any component of an electronic device processing tool or system. Some examples of such components include a substrate support assembly, an electrostatic chuck, a gas delivery plate, a lid, a nozzle, a liner, a ring (e.g., a process kit ring or single ring), a base, a showerhead, gas lines, a liner kit, a shield, a plasma screen, a flow equalizer, a cooling base, a chamber viewport, a chamber lid, a link or arm of a robot, and so on.

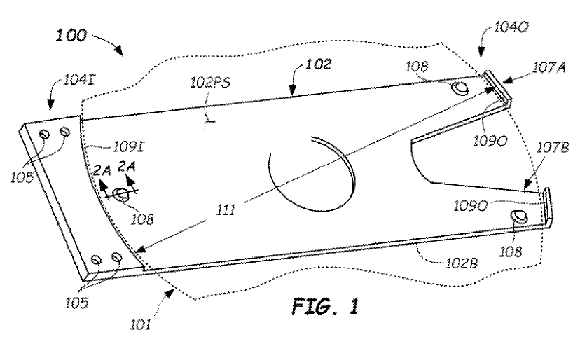

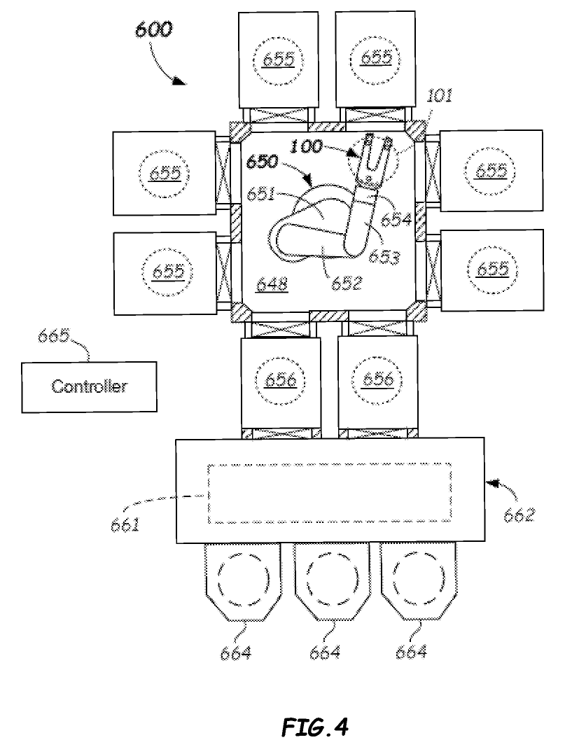

FIG. 1 depicts an embodiment of a chamber component that may include a metal matrix composite described herein. In FIG. 1, the chamber component is an end effector 100 configured to support a substrate 101 (a portion thereof shown dotted). The end effector 100 may be made up of an end effector body 102 having a top surface and a bottom surface 102B. The top surface may comprise a plane containing three spot faces that are raised above an underlying planar surface 102PS of the end effector body 102. The end effector body 102 may be configured to couple or interconnect to a robot component at an inboard end 104I, such as to a robot arm (e.g., robot wrist 653 – see FIG. 4). Coupling may be by way of fasteners (not shown) received through bores 105 thus coupling the end effector 100 to the robot arm (e.g., wrist 653). Coupling may be made directly to the wrist member 653 or through and intermediate component such as a mounting plate 654 (FIG. 4) in order to reduce cracking of the end effector 100.

An outboard end 104O of the end effector body 102 can includes first fork 107A and second fork 107B, each of which can be configured to receive and support a contact pad 108 thereon. The contact pads 108 on the outboard end 104O and a third contact pad 108 proximate the inboard end 104I can provide for stable three-point contact supporting the substrate 101 thereon (only a portion of substrate 101 shown in FIG. 1). Substrate 101 can be supported on the contact pads 108 of the end effector 100 between an inboard shelf 109I, which may be an arcuate step of approximately a same radius as the substrate 101, and outboard shelves 109O. Spacing between the respective inboard shelves 109I and outboard shelves 109O can be slightly larger (e.g., a few mm) than the substrate 101, such as where dimension 111 may be a diameter that is slightly larger than 300 mm in diameter or 450 mm in diameter or other dimension of the substrate 101. Other configurations of the end effector body 102 other than shown can be used. The end effector body 102 may include a reinforcement feature formed from a metal matrix composite and/or may be manufactured from a metal matrix composite in embodiments. The end effector body 102 may be manufactured from a metal. In some embodiments, the metal may include aluminum or an aluminum alloy. One or more reinforcement features (not shown) added to the end effector body 102 may include one or more layers on a top and/or bottom of the end effector body 102, one or more strips of material added to the top and/or bottom of the end effector body 102, one or more rectangular features inserted into cavities formed in the top and/or bottom of the end effector body 102, and so on. In one embodiment, the reinforcement feature(s) comprise a tape bonded (e.g., welded, diffusion bonded, metal bonded, by adhesive, by UAM etc.) to the end effector body 102. In one embodiment, the reinforcement features have a thickness of about 0.015 inches as compared to a thickness of about 0.175 inches of the end effector body 102. In embodiments, the reinforcement features have a thickness that is about 5-25% of a thickness of the end effector body (e.g., about 8-10% of a thickness of the end effector body).

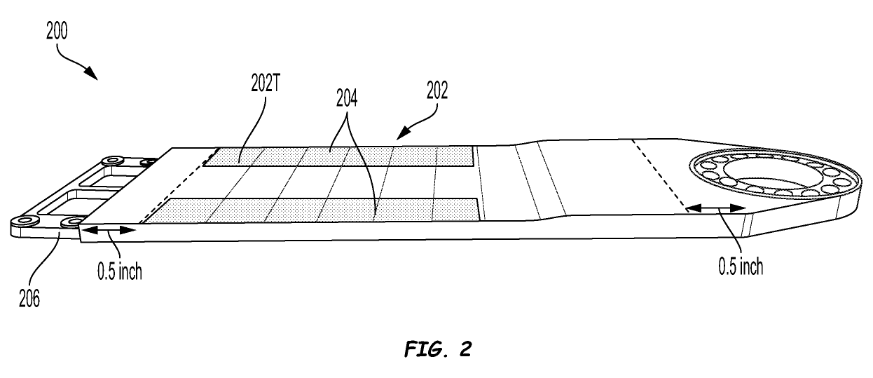

FIG. 2 is a side/top view of an additional end effector 200 having an end effector body 202 depicting top surface 202T, and reinforcement features 204 attached on top surface 202T. As can be seen in FIG. 2, the reinforcement features 204 are attached to the top surface 202T of end effector body 202 at sides of the top surface 202T such that the reinforcement features 204 are aligned with a longitudinal axis of the end effector body 202. The reinforcement features may be formed of a metal matrix composite as described herein. The metal matrix composite may include a metal matrix and a plurality of fibers in the metal matrix. In some embodiments, the plurality of fibers may include any of the fibers described herein. In some embodiments, the plurality of fibers may include continuous fibers. In some embodiments, the plurality of fibers may be alumina fibers, carbon fibers, boron fibers, ceramic fibers or glass fibers, SiO₂ fibers or a combination thereof. In some embodiments, the plurality of fibers may be alumina fibers. In some embodiments, the metal matrix may include aluminum or an aluminum alloy. In some embodiments, the metal matrix may include magnesium or a magnesium alloy. In some embodiments, the metal matrix composite may include an aluminum alloy and an alumina fiber. In some embodiments, the fibers of the metal matrix composite may be aligned with the longitudinal axis of the end effector body 202. This may increase a stiffness of the end effector body 202, and minimize (sagging of the end effector body 202 as well as) vibration of the end effector 200 during and after movement.

Addition of the reinforcement features 204 formed from the metal matrix composite modifies the properties of the end effector, such as stiffness. The metal matrix composite (MMC) is lighter than Al6061 but mechanically stronger. The MMC has a stiffness of 30 million lb/in2 (msi) or 207 GPa, which is similar to that of high-strength steel. The improvement of the mechanical properties of the end effector will allow simplification of part design for end effectors (and optionally for robot arm links), making them less massive, making them lighter, causing reduced material thickness, and so on. The MMC may be formed as a sheet of material, which may be cut and bonded to one or more surface of the end effector body 202 and/or inserted into one or more cavities formed in the end effector body 202 in embodiments. Accordingly, the end effector may be fabricated using conventional and proven technologies, while still benefiting from advanced properties of the MMC in embodiments.

In some embodiments, the metal of the end effector body and the metal of the metal matrix composite may be the same. For example, both the end effector body and metal matrix composite may include aluminum or an aluminum alloy. In some embodiments, the metal of the end effector body may include an aluminum alloy including aluminum and at least one of silicon and magnesium.

In some embodiments, the metal matrix composite may include continuous fibers. The continuous fibers may be oriented parallel to the length of the metal matrix composite. In some embodiments, the continuous fibers may be oriented to be transverse, or any orientation between parallel and transverse to the length of the metal matrix composite. In some embodiments, multiple layers of the metal matrix composite and/or reinforcement features formed from the MMC are used, those layers/reinforcement features having fibers with different orientations. For example, one layer or feature may have fibers that run along the longitudinal axis of the end effector body, while another layer or feature may have fibers that run along the transverse axis of the end effector body.

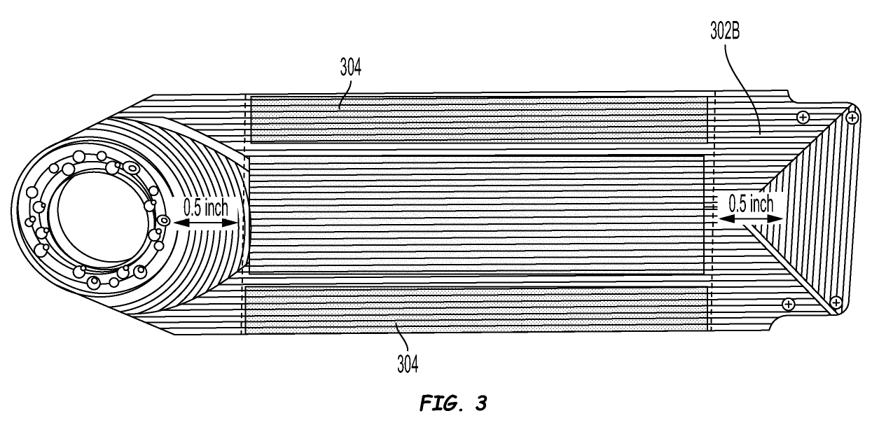

As illustrated in FIG. 2, the reinforcement feature 204 may extend along a longitudinal axis of the end effector body 202 such that the reinforcement feature 204 is along the edges of the end effector body 202. In some embodiments, the reinforcement feature 204 may be placed in similar locations along the bottom surface 302B of the end effector body 202 as illustrated in FIG. 3 (See reinforcement feature 304). In some embodiments, the reinforcement feature 204 may be disposed in at least one of a first cavity on the top surface 202T of the end effector body or a second cavity on a bottom surface of the end effector body (not pictured.) As illustrated in FIG. 2, in one embodiment the reinforcement feature 204 begins about 0.5 inches from the inner end 206 and does not extend fully through the length of the top surface 202T. In some embodiments, the reinforcement feature 204 may extend along the entire length of the top surface 202T or may extend along a portion of the top surface 202T.

The end effector body 202 may be manufactured from a rigid material. In some embodiments, the end effector body 202 may be made of a stable, lightweight material that reduces the end effector’s deflection under varying chamber processing conditions including pressure and temperature. Suitable, non-limiting, materials for the end effector body 202 include insulating material or conductive materials, such as, without limitations, a polymer, glass, quartz, ceramic, or a conductive material (such as a metal material). In some embodiments, the end effector body 202 may include a metal material.

For example, a ceramic such as bulk alumina can be used. In some embodiments, suitable ceramics may be semi-conductive to facilitate the discharge of any electrostatic charge that may build up on the substrate. Other semi-conductive ceramic materials include, for example, alumina-SiC composites, SiC, silicon nitride, boron nitride, and boron. Any such materials may be reinforced using layers and/or features formed of the MMC described herein.

In some embodiments, the end effector body 102 of FIG. 1 or 202 of FIG. 2 may include a conductive material such as a metal. Exemplary suitable conductive materials may include, without limitations, stainless steel, aluminum, nickel, copper, chromium, cobalt, molybdenum, ruthenium, tungsten, or platinum, for example. Other suitable metals or alloys (e.g., aluminum alloy Al6061) can also be used. An end effector body (or another chamber component) may also include a metal matrix composite in the form of a reinforcement feature to improve the material properties of the end effector body (or another chamber component).

As noted above, FIG. 3 illustrates the bottom of an end effector body. As can be seen in FIG. 3, the bottom surface 302B includes a reinforcement feature 304. The end effector body of FIG. 3 corresponds to that of the end effector body 202 described in FIG. 2. The end effector body of the bottom surface 302B includes a reinforcement feature 304 formed from the metal matrix composite described in FIG. 2. The reinforcement feature 304 may be placed on the outer edges as noted above or may expand along the center of the bottom surface 302B as seen in FIG. 3.

FIG. 4 illustrates an example embodiment of an electronic device processing tool 600 including a transfer robot 650 having an end effector 100 supporting a substrate 101 (shown dotted for illustration purposes) wherein the substrate 101 is supported on contact pads (integral or replaceable). End effector 100 (with or without the contact pad deposited thereon) may be include one or more reinforcement features including a metal matrix composite as described herein. The electronic device processing tool 600 may include a number of processing chambers 655 (shown dotted) coupled to a transfer chamber 648. The transfer chamber 648 may house the transfer chamber (TC) robot 650. The TC robot 650 may have a first arm 651, a second arm 652, and a third arm 653 (e.g., a robot wrist). The end effector 100 is coupled to the third arm 653, such as through mounting plate 654. The end effector 100 may contact and support a substrate 101 thereon (e.g., a semiconductor wafer, glass plate, etc.).

The transfer chamber 648 of the processing tool 600 may be connected, via one or more load lock chambers 656, to a factory interface 662. The factory interface 662 may house a factory interface (FI) robot 661. The FI robot 661 may include an end effector (not shown, but substantially identical to end effector 100) and that can have replaceable contact pads 108 as described herein and may have a reinforcement feature attached including a metal matrix composite as described herein.

Substrate carriers 664 may be detachably connected to a front wall of the factory interface 662 and substrates 101 therein may be moved by the FI robot 661 between the substrate carriers 664 and the one or more load lock chambers 656.

The processing tool 100 may be coupled to a controller 665. The controller 665 may control movement of the substrates 101 and processing thereof. The controller 665 may include a central processing unit (CPU), support circuits, and a memory, for example. In operation, the TC robot 650 may be operated, subject to commands from the controller 665, to move substrates 101 between the various process chambers 655 and the load lock chambers 656 or between different process chambers 655, for example.

As the manufacturing processes progress, the FI robot 661 and the TC robot 650, working in tandem, may move substrates 101 between the substrate carriers 664 and the processing chambers 655. Various electronic device fabrication processes, e.g., semiconductor device manufacturing processes, such as, e.g., oxidation, thin film deposition, etching, heat treatment, degassing, cool down, etc., may take place within the process chambers 655.

Though TC chamber robot 650 is described as having an end effector coated with an electrically-dissipative coating, the FI robot 661 may additionally or alternatively include an end effector with an electrically-dissipative coating.

In the foregoing description, numerous specific details are set forth, such as specific materials, dimensions, processes parameters, etc., to provide a thorough understanding of the present invention. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is simply intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment.

The present invention has been described with reference to specific exemplary embodiments thereof. The specification and drawings are, accordingly, to be regarded in an illustrative rather than a restrictive sense. Various modifications of the invention in addition to those shown and described herein will become apparent to those skilled in the art and are intended to fall within the scope of the appended claims.

We claim:

1. An end effector for a robot arm, comprising:
a metal end effector body; and
a reinforcement feature attached to the end effector body, the reinforcement feature comprising a metal matrix composite comprising a metal matrix and a plurality of fibers in the metal matrix.

2. The end effector of claim 1, wherein the plurality of fibers comprises continuous fibers.

3. The end effector of claim 1, wherein the plurality of fibers comprises crystalline fibers.

4. The end effector of claim 1, wherein the plurality of fibers comprise alumina fibers, carbon fibers, boron fibers, ceramic fibers, glass fibers, SiO₂ fibers, or a combination thereof.

5. The end effector of claim 1, wherein the metal of the metal end effector body comprises aluminum or an aluminum alloy, and wherein the metal matrix comprises aluminum or an aluminum alloy.

6. The end effector of claim 1, wherein the metal matrix composite comprises an aluminum alloy and an alumina fiber.

7. The end effector of claim 1, wherein the metal of the metal end effector body comprises aluminum and at least one of silicon or magnesium.

8. The end effector of claim 1, wherein the reinforcement feature extends along a longitudinal axis of the metal end effector body and is disposed in at least one of a first cavity on a top surface of the metal end effector body or a second cavity on a bottom surface of the metal end effector body.

9. The end effector of claim 1, wherein the metal end effector has a stiffness of about 200 GPa to about 250 GPa as a result of the reinforcement feature.

10. The end effector of claim 1, wherein the metal matrix composite comprises about 20% to about 50% of the plurality of fibers.

11. A robot comprising:
a robot arm comprising:
a metal end effector body; and
a reinforcement feature attached to the metal end effector body, the reinforcement feature comprising a metal matrix composite comprising a metal matrix and a plurality of fibers in the metal matrix.

12. The robot of claim 11, wherein the plurality of fibers comprises continuous fibers.

13. The robot of claim 11, wherein the plurality of fibers comprises crystalline fibers.

14. The robot of claim 11, wherein the plurality of fibers comprises alumina, carbon, boron, ceramic, glass fibers, or a combination thereof.

15. The robot of claim 11, wherein the metal of the metal end effector body comprises aluminum or an aluminum alloy and wherein the metal matrix comprises aluminum or an aluminum alloy.

16. The robot of claim 11, wherein the metal matrix composite comprises aluminum alloy and an alumina fiber.

17. The robot of claim 11, wherein the metal of the metal end effector body comprises aluminum, and at least one of silicon or magnesium.

18. The robot of claim 11, wherein the reinforcement feature extends along a longitudinal axis of the metal end effector body and is disposed in at least one of a first cavity on a top surface of the end effector body or a second cavity on a bottom surface of the end effector body.

19. The robot of claim 11, wherein the metal end effector has a stiffness of about 200 GPa to about 250 GPa as a result of the reinforcement feature.
